(19) United States
(12) Patent Application Publication
(10) Pub. No.: US 2017/0085211 A1
(43) Pub. Date: Mar. 23, 2017

(54) METAMATERIAL BASED EMITTERS FOR THERMOPHOTOVOLTAICS

(71) Applicant: The Governors of the University of Alberta, Edmonton (CA)

(72) Inventors: Sean Molesky, Edmonton (CA); Zubin Jacob, Edmonton (CA)

(21) Appl. No.: 14/536,085

(22) Filed: Nov. 7, 2014

Related U.S. Application Data
(60) Provisional application No. 61/901,284, filed on Nov. 7, 2013.

(51) Int. Cl. H02S 10/30

(52) U.S. Cl. CPC H02S 10/30

(57) ABSTRACT

A thermal emitter is provided, including a periodic structure operating as a metamaterial on an optically thick substrate; the periodic structure thermally emitting at high temperatures in a specified narrow wavelength of a predetermined resonance, the metamaterial including a composite medium of natural materials. The emitter may be part of a thermophotovoltaic device. The thermal emitter may include a plurality of layered films, wherein the distance between each adjacent film is substantially less than the wavelength.

### RELATED APPLICATIONS

This application claims the benefit of U.S. Provisional Patent Application 61/901,284 filed Nov. 7, 2013, which is hereby incorporated by reference in its entirety.

### FIELD

The present invention relates to voltaics, and more particularly to thermovoltaics.

### BACKGROUND

Thermophotovoltaics theoretically provide a simple, feasible way to convert up to 85% of solar and waste heat energy into usable power. However, the realization of this potential is strictly dependent on the degree that thermal emitters can be engineered.

High temperature energy conversion processes, such as combustion, are accompanied by thermal losses which often outstrip usable produced power. As an example, for average oil and coal based energy conversion, thermal losses account for roughly 50% to 60% of the total produced power. For small internal combustion engines this number may climb as high as 75%. These losses can be substantially mitigated by utilizing the waste thermal energy as a heat resource. An ideal configuration would convert waste thermal energy directly into usable power.

Thermal losses are also significant for photovoltaic cells. Due to the large spectral range that must be captured, over 60% of incident solar power is lost as thermal energy. Regardless of the material bandgap's spectral position, radiation above the bandgap loses a portion of its energy to thermalization within the cell. Radiation with energy below the bandgap is essentially unused. These effects are intrinsic and place an upper limit on energy conversion for a single junction semiconductor cell. While proposals of multi junction cells offer a potential workaround, they also require a shift to expensive materials and structures.

An alternative solution exists in the application of the thermophotovoltaic (TPV) method. In this approach, any combination of conductive, convective or radiated waste energy is concentrated to heat a structure with a spectral emission tailored to match the bandgap of a specific photovoltaic cell. Once the structure is heated, the source energy is converted to electromagnetic radiation which can be transformed into electric power with high efficiency. The method of maintaining the heated source is flexible giving the TPV approach applicability beyond that of large scale solar or solar thermal approaches. For example, TPV methods can be used to create compact devices for cogeneration of heat and electricity.

TPV devices can easily be integrated as efficiency increasing components of larger systems, or function as primary solid state energy converters. However, the operational temperatures needed for sufficient power generation and efficient energy conversion, as well as the limits in tuning the thermal radiation spectrum, has made previous TPV approaches largely impractical. While progress has been made towards designing emitters for far field TPVs through surface structuring, planar Fabry-Perot based structures and photonic crystals, a dominant, broadly applicable set of tools for controlling thermally induced radiation has yet to emerge.

Various thermal emitters have been designed making use of optically metallic photonic crystals, surface structuring, and resonant planar structures. Yet these various methods for modifying thermal radiation properties have limitations. More specifically, the photonic crystal approach suffers from an inherent difficulty in tuning the width of the emission resonance and the creation of a wide band gap for the suppression of unwanted thermal emission. This causes either unwanted emission at longer wavelength than the design resonance, or relatively wide peaks which lack the ideal sharp cut off. Planar structures are much less compact than any of the other designs, and, due to the Fabry-Perot nature of the emission resonance, tend to be spectrally narrow and angularly sharp. The general features of the planar structure combine to produce significantly lower emitted power than the other thermal emitters at a given temperature; an obvious determent to the most important application of thermally simulated emitters; energy conversion. Finally, surface structuring approaches have limited control over the spectral width of emission in direct comparison of thermal emission resonances.

It is commonly understood that thermodynamic arguments illustrate that the efficiency of a perfect single p-n junction photovoltaic can be no greater than 31% for a blackbody source. There has been great interest in finding other more efficient methods to harness electromagnetic radiation. However, in sticking to the more cost effective and easily fabricated single junction photovoltaic design, the fundamental limiting factors remain. Primarily the traditional single junction photovoltaic cell is greatly limited by the usable power available once a single bandgap has been set. Electromagnetic radiation with energy below that of the bandgap has such low charge carrier creation efficiencies that for practical purposes it is essentially unused. Electromagnetic radiation with energy above the bandgap losses its additional energy to thermalization within the cell, producing carriers at the band edges. Here, the idea of thermophotovoltaics holds great promise. In the thermophotovoltaic approach, incident light, or waste heat from an industrial process, is used to thermally excite an engineered emitter. This selective emitter then acts a radiation source for the photovoltaic cell. By matching the spectral content of the emitter to wavelengths slightly shorter than that of the bandgap, the principle loss mechanism of the traditional photovoltaic cells is greatly reduced. The characteristics needed for the emitter portion of a thermophotovoltaic cell are a narrow but finite spectral emission width, a broad angular shape and a resonance position at wavelengths slightly shorter than the bandgap.

### SUMMARY

The use of nanowires, or a sub-wavelength planar layer, to create effective bulk materials with optical properties well beyond those found in nature, broadly known as metamaterials, has been confined to near or significantly below room temperature. Since many of the most interesting applications of thermal engineering are based on energy harvesting and thus by direct connection, through the blackbody power distribution, high temperatures often above 1500K, the scope of traditional optical metamaterials for thermal engineering applications is restricted. However, this limitation is material based. By switching away from the conventional thermally unstable metals, such as silver and gold which have been used almost exclusively in present optical metamaterial designs, to more thermally robust transition metals, such as an interstitial nitride, a transition metal, or transparent conductive oxide semiconductors, optical metamaterial designs can be used in the thermal regime above 800 K. Specific examples of more stable metamaterials according to the invention can include, but is not limited to, titanium nitride, tantalum and aluminum zinc oxide. This change from gold and silver to alternative optical metals is also beneficial for fabrication of optical metamaterial structures. In particular, whereas the growth of smooth gold and silver films is quite difficult and only possible down to approximately 9 nm, titanium nitride can be deposited by atomic layer deposition with layer thickness below a single nanometer.

Various selective thermal emitters have been designed making use of optically metallic photonic crystals, surface structuring, and resonant planar structures. Yet none of these various methods for modifying thermal radiation properties match the combination of spectral width control, angular character and spectral emission position achievable using the emitters according to the invention.

The optical metamaterial approach according to the invention has improved control over the spectral width of emission in direct comparison of thermal emission resonances. The combination of spectral width, control over resonance position, and variable angular absorbance make the optical metamaterial emitter according to the invention a primary tool for thermal engineering and thermalphotovoltaics applications.

Three significant characteristics differentiate the emitters according to the invention from the previous art. In a similar fashion to the photonic crystal approach, the emitters are available in a periodic medium with a repeatable unit cell. However, the emitter according to the invention operates in the effective medium or bulk response limit. The emitter according to the invention does not depend on the crystalline nature or photonic bandgaps as in the prior art. While the term metamaterial can be applied very broadly, to both surface structuring methods and periodic structures, the constraints of an effective medium are much tighter. Most importantly, it means that characteristic interaction between electromagnetic radiation at the design wavelength of emission is accurately described in terms of effective medium parameters. For our purpose, in terms of numerics, this can be roughly translated as all but one size parameter in the repeated unit cell is smaller than a tenth of the free space wavelength of the designed resonance for thermally emitted radiation. Finally, the effective medium, or strict metamaterial limit of the emitter, means that the particular subwavelength structure is only consequential in that it determines the effective medium parameters. No other deeply sub wavelength effective medium design following these constraints has been proposed as a selective thermal emitter.

The emitters and method according to the invention include engineering thermally excited far field electromagnetic radiation using epsilon-near-zero metamaterials, and a class of artificial media, epsilon-near-pole metamaterials. High temperature plasmonics used as conventional metamaterial building blocks have relatively poor thermal stability. The angular nature, spectral position, and width of the thermal emission can be finely tuned for a variety of applications. In particular, the metamaterial emitters near 1500 K can be used as part of thermophotovoltaic devices to surpass the full concentration Shockley-Queisser limit of 41%.

A class of thermal effects in metamaterials for thermophotovoltaic applications is provided. The approach includes engineering the poles and zeros of the dielectric constant which allow for an array of unique optical responses. Epsilon-near-zero (ENZ) metamaterials behave as spectrally tunable, narrowband ultra-thin thermal emitters and the invention provides a class of artificial media, epsilon-near-pole (ENP) metamaterials. These ENP metamaterials are ideally suited as thermal emitters in a thermophotovoltaic system where the main requirements are: (1) omnidirectional thermal emission; (2) narrow-band and high emissivity; and (3) polarization insensitivity. The invention also addresses one of the major limitations of conventional metamaterials for thermal applications: high temperature operation; by switching to plasmonic materials with high melting points.

A thermal emitter is provided, including a periodic structure operating as a metamaterial on an optically thick substrate; the periodic structure thermally emitting at high temperatures in a specified narrow wavelength of a predetermined resonance, the metamaterial including a composite medium of natural materials. The emitter may be part of a thermophotovoltaic device. The thermal emitter may include a plurality of layered films, wherein the distance between each adjacent film is substantially less than the wavelength.

The thermal emitter may further include a plurality of nanowires positioned in the metamaterial, each of the nanowires positioned at a distance from adjacent nanowires and each of the nanowires having a diameter, wherein the distance and the diameter are each significantly less than the wavelength.

The emitter may use absorption resonances of anisotropic metamaterials for thermal emission. The composite material in the metamaterial may be a high temperature plasmonic material with a frequency at which the relative dielectric response crosses zero and a melting temperature above 800 K. The composite material in the metamaterial may be an interstitial nitride; a transition metal; a transparent conductive oxide semiconductor, aluminum zinc oxide; tantalum; or titanium nitride.

The thermal emission may be is reliant upon the thermal excitation of plasmon modes. The thermal emission may occur at a frequency above a bandgap of a gallium antimonide photovoltaic cell. Significantly less than the wavelength may be no greater than 10% of the wavelength over an operational range.

The thermal emission may be matched to the predetermined resonance, and occur at an engineered plasma frequency of the metamaterial; the engineered plasma frequency within a frequency region wherein one of the components of a real relative dielectric response of the metamaterial crosses zero.

The thermal emitter may be matched to the predetermined resonance and occur in a wavelength region where a relative dielectric response component of the metamaterial has the greatest change of the response component's second derivative with respect to wavelength.

The metamaterial may be a high temperature metamaterial. The composite material of the emitter may be titanium oxide.

A method for precisely manipulating thermal emission properties through the use of manmade deeply sub-wavelength resonant structures is also provided. In this method, a periodic lattice of nanowires with metallic optical behavior is interspersed in a matrix of optical dielectric to create an effective bulk material at the emission range of interest. By varying the particular geometry and composition of the sub-wavelength units, the electromagnetic thermal emission resonances of the effective material can finely tuned from the blue end of the visual spectrum, 300 nm wavelength, to the mid infrared, 10 μm. The precise control of the emission resonance, narrow spectral width and angularly tunable nature of thermal resonances afforded by these effective medium structures presents control over thermally induced radiation, and a path for applied thermal engineering. Employing sample designs of these optical metamaterial emitters as part of thermophotovoltaic cell demonstrates more than 40% energy conversion efficiency for emitter temperatures below 1500K.

### DESCRIPTION OF THE DRAWINGS

FIGS. 1(a) and 1(b) are schematic drawings of embodiment of a metamaterial emitter according to the invention.

FIG. 2 is a drawing of a photovoltaic cell including a metamaterial emitter according to the invention.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

Kirchhoffs law of thermal radiation for a body in thermodynamic equilibrium, provides that the engineering of thermal emission can be formulated in terms of optical absorptivity:

ζ(λ,θ,φ)=α(λ,θ,φ)

with α (λ, θ,φ) denoting the structure's absorptivity as function of wavelength, azimuthal angle, and polar angle, and ζ denoting the structure's emissivity. It follows directly that spectrally narrow regions of high optical absorption also create spectrally narrow regions of high thermal emission. Consequently, the use of optical resonances provides a natural starting point for designing thin structures to control thermally excited electromagnetic radiation. The fundamentally distinct natures of the bulk material resonances can create a range of thermally induced effects. The emitter according to the invention can be used for a variety of applications and in particular for TPV emitters, where the main constraints on the emitter are narrowband and omnidirectional emissivity. The emitters according to the invention incorporate metamaterials, including Epsilon-near-zero (ENZ) or Epsilon-near-pole (ENP) metamaterials

ENZ: Lossless or near lossless epsilon-near-zero resonances have been shown as a plausible mechanism for creating high performance optical devices ranging from nonlinear optical switches to tailored radiation phase patterns. ENZ resonances have important applications in general control of thermally induced radiation. However, the traditional Re (ε)→0 and Im (ε)→0 ENZ regime is not suited to the requirements of a TPV emitter.

However, P-polarized radiation incident on an ENZ slab shows increased absorption (non-normal incidence). This resonance arises due to the presence of a field enhancing mechanism that relies on the displacement field boundary condition: ε₁E₁⊥=ε₂E₂⊥ where the ⊥ denotes the direction perpendicular to the slab, and either medium can be assumed to have ENZ behavior (if ε₂2→0 then E₂⊥→∞). Kirchoffs law reveals that this ENZ slab with enhanced absorption should show a high emissivity. However, s-polarized light which does not have a component of the field perpendicular to the slab does not show this field enhancement or the ENZ resonance. By this constraint, no s-polarized light can be thermally excited, and p-polarized radiation cannot be efficiently emitted at low polar angles. Since the emission of an ideal blackbody shows no angular or polarization preference, the maximal averaged emitted spectral power in an ENZ region is less than half of what can be achieved theoretically.

Nevertheless, polarization averaged emissivity near that of a blackbody can still be attained if the Im (ε)→0 condition is relaxed. In moving away from true ENZ behavior by the addition of extra loss, two separate, but connected, absorption improving effects occur. First, in the Re (ε)→0 region, the high impedance mismatch between an ENZ material and free space is greatly reduced as the added loss acts to decrease the impedance of the material. Since this also dictates a general relaxation of ENZ resonance characteristics, polarization sensitivity is greatly diminished. Second, at wavelengths shorter than the Re (ε)→0 crossing where material impedance is similar to that of free space (Re (ε)≈1) the addition of material losses begins to allow for significant absorptivity even if the material of the film is thin. Both effects push this pseudo ENZ resonance towards near-omnidirectional and high absorptivity for both electromagnetic polarizations. At higher losses, they combine to create a single highly absorptive spectral region.

Yet, improving absorptivity in this manner comes at the cost of an increased spectral width. Due to the natural dispersion limitations of a region where Re (ε)→0, the spectral width over which the additional loss achieves impedance matching is comparatively broad. As a direct result, high emissivity occurs over a much wider range than that ideal for high efficiency TPVs. Again, while broader emissivity may be useful for certain TPV applications, it does not match the ideal narrowband criterion. In light of these results, the emitter according to the invention can use ENP resonances for achieving the thermal emission characteristics necessary for high efficiency TPVs. Note that both the ENZ and ENP resonances can be engineered using nanostructured metamaterials.

ENP: The primary advantage of operating at an ENP resonance is the extremely dispersive nature of these regions. This characteristic allows for tight spectral control even with moderate material losses. Yet, beyond this most important feature, several other benefits for TPV type emitters and absorbers exist. At an ideal pole of the dielectric constant, Re (ε)→(±)∞. The addition of losses regularizes the singularity, reduces impedance mismatch and leads to enhanced absorption (high emissivity) in a narrow spectral region. The ENP resonance associated with such a pole shows no polarization sensitivity and achieves omnidirectional high emissivity in isotropic media.

In natural materials, ENZ regions occur at bulk plasmon as well as longitudinal optical phonon resonances, while ENP characteristics are related to transverse optical phonons. Yet, despite the ubiquity of these features in optical responses, few materials exhibit ENZ or ENP characteristics in the 0.5 eV to 1.0 eV range, crucial for TPV devices. The bulk of plasmon energy, proportional to (ωₚα(N/mₑ)^{1/2}, is generally pushed to much higher energies due to the small effective electron mass, mₑ, and the high electron concentration, N≈10²² cm⁻³, of typical metals. The energy of material phonon resonances, proportional to ωLOαωTOα(1/M)^{1/2} occurs at significantly lower energies due to the relatively large reduced ionic mass, M. The prospect of natural ENP or ENZ infrared emitters is limited to a small collection of highly lossy materials such as osmium or molybdenum, which are not capable of creating the spectrally narrow emission required for high efficiencies.

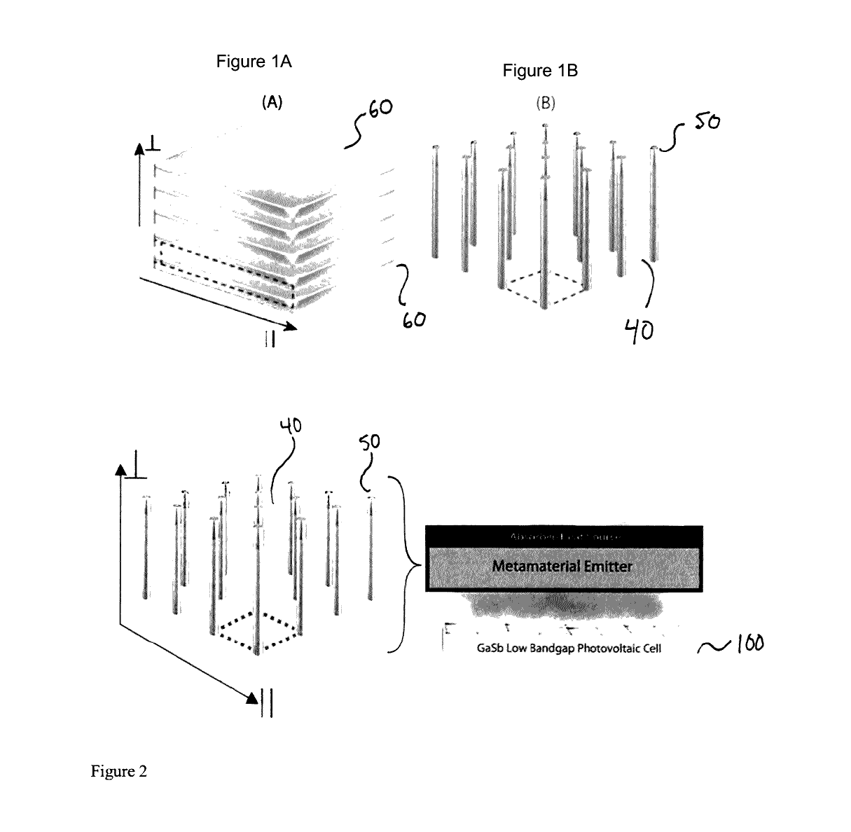

The system according to the invention provides for the use of nanowires 50 embedded within a dielectric substrate 40, or sub-wavelength planar layers 60, as shown in FIGS. 1(a) and 1(b) to create effective bulk materials with optical properties (e.g., ENP and ENZ responses) well beyond those found in nature. Such materials, broadly known as metamaterials, have been confined for use to near or significantly below room temperature. Since many of the most interesting applications of thermal engineering are based on energy harvesting and thus by direct connection through the blackbody power distribution, high temperatures (often above 1500K), the scope of traditional optical metamaterials for thermal engineering applications is quite restricted. However, this limitation is strictly material based. By switching away from the conventional thermally unstable metals, such as silver and gold which have been used almost exclusively in present optical metamaterial designs, to more thermally robust transition metals, such as an interstitial nitride, a transition metal, or transparent conductive oxide semiconductors, optical metamaterial designs can be used in the thermal regime above 800 K. Specific examples of more stable metamaterials according to the invention can include, but is not limited to, titanium nitride, tantalum and aluminum zinc oxide This change from gold and silver to alternative optical metals is also beneficial for fabrication of optical metamaterial structures. In particular, whereas the growth of smooth gold and silver films is quite difficult and only possible down to approximately 9 nm, titanium nitride can be deposited by atomic layer deposition with layer thickness below a single nanometer.

In some embodiments, the thermal emission is reliant upon the thermal excitation of plasmon modes. The physical mechanism behind the thermal radiation emission patterns created by optical metamaterial emitters according to the invention is a coupling of the resonant plasmon modes of the metallic sub-wavelength units that make up the effective bulk material. However, as the far-field emission with various design geometries in this microscopic picture is equivalent to the effective medium view with negligible differences, the control of thermal emission provided by the nanowire structure can be described by metamaterial concepts. First a spatial averaging of the optical properties of the medium using a generalized Maxwell-Garnet technique is used. Then the resulting optical responses of the now effective medium can be used to create a representative bulk medium. For instance, considering the nanowire geometry with a square lattice, the effective medium parameters are found to match those of an uniaxial crystal with optical responses defined as:

$${ε}_{\vert \vert} = {ε}_{D} [ \frac{{ε}_{M} ( 1 + ρ ) + {ε}_{D} ( 1 - ρ )}{{ε}_{M} ( 1 - ρ ) + {ε}_{D} ( 1 + ρ )} ]$$

$${ε}_{⊥} = {ρε}_{M} + ( 1 - ρ ) {ε}_{D}$$

wherein the parallel and perpendicular components are as shown in the FIG. 2, the response of the optical dielectric is denoted by the subscript D, that of the optical metal by the subscript M, and ρ represents the fill factor of the optical metal in the unit cell. Following the general behavior of an optical metal, shown in the second figure, it is clear that if the optical response, or equivalently for our purposes permittivity of the host matrix, varies slowly with changing wavelength that zeros will occur both in the denominator of the parallel and numerator of the perpendicular components of the effective medium permittivity. Near these permittivity zeros, which are the effective material resonances, material absorption is greatly amplified. By virtue of the rigorously defined arguments of Kirchhoffs law of thermal radiation, which states that at thermal equilibrium energy cannot flow into or out of a body for all directions and wavelengths, these material resonances are also constitute radiation emission peaks when the structure is heated.

While both resonances occur as the re-radiated electromagnetic radiation from the subwavelength building blocks destructively interferes with the exciting wave, their physical characteristics are distinct. Electromagnetic radiation for all incident angles and polarizations interacts with the parallel permittivity. Only radiation with an electric field component perpendicular to the effective medium interacts with the perpendicular permittivity component. This gives rise to an omnidirectional emission peak arising from the parallel permittivity resonance and an angularly needle like characteristic for the perpendicular. Secondly, in comparing the effective permittivity constants, the two resonance conditions are unique. The perpendicular resonance always occurs when the real part of the effective permittivity is near zero, and is only broadened by material loss. Contrarily, while the wavelength position of the resonance remains fixed, the variation of the real effective permittivity decreases as material loss in the component materials, and thus effective medium constants, is increased. The behavior of the parallel resonance is similar to the resonance of a Lorentz oscillator, while the perpendicular resonance is more comparable to the plasma resonance of a metal. This result is intuitive from both the macroscopic effective medium theory, and the microscopic viewpoint of coupling modes. The parallel resonance is the harmonic resonance of the effective optical dielectric in the parallel direction, and is correspondingly linked to a single electromagnetic transverse mode of the sub wavelength structure. The perpendicular resonance is the bulk plasma resonance of the effective optical metal in the perpendicular direction, and is correspondingly a mixing of two modes, a longitudinal, or plasma mode, and a normal transverse mode in both viewpoints. The angularly dependent interference between the two modes provides an additional tool for modifying the angular dependence of the perpendicular resonance.

The narrow spectral width of both modes is linked to the material losses in the structure. Following the above example of nanowires square lattice points in an optical dielectric, as shown in FIG. 1(b), it is apparent that the particular geometry of the underlying microscopic structure can also be used to manipulate the imaginary part of the effective permittivities. These parameters act as the effective optical losses, and in turn modify the shape of the effective material resonances. Thus, by alternating the wavelength units the position of the material resonances can be tuned, but also to a large degree, their spectral widths. No other current thermal emitter design can simultaneously control the spectral position, width and angular shape of all its thermally emitted radiation to the same extent as the metamaterial based design.

In a thermophotovoltaic use of an emitter according to the invention, as shown in FIG. 2, incident light, or waste heat from an industrial process, is used to thermally excite an engineered emitter. This selective emitter then acts a radiation source for the photovoltaic cell 100. By matching the spectral content of the emitter to wavelengths slightly shorter than that of the bandgap, the principle loss mechanism of the traditional photovoltaic cells is greatly reduced. The characteristics needed for the emitter portion of a thermophotovoltaic cell are a narrow but finite spectral emission width, a broad angular shape and a resonance position at wavelengths slightly shorter than the bandgap. All three of these features are reproduced nearly identically using the parallel optical dielectric resonance of the metamaterial emitters.

Most immediately, the metamaterial emitter design according to the invention can be directly applied to existing thermophotovoltaic applications for both direct solar energy conversion and waste heat from large scale industrial processes. In some embodiments, the thermal emission occurs at a frequency above a bandgap of a gallium antimonide photovoltaic cell.

Therefore, the thermal emission properties can be precisely manipulated, through the use of manmade deeply sub-wavelength resonant structures. For example, a periodic lattice of nanowires with metallic optical behavior can be interspersed in a matrix of optical dielectric to create an effective bulk material at the emission range of interest. By varying the particular geometry and composition of the sub-wavelength units, the electromagnetic thermal emission resonances of the effective material can finely tuned from the blue end of the visual spectrum, 300 nm wavelength, to the mid infrared, 10 μm. The precise control of the emission resonance, narrow spectral width and angularly tunable nature of thermal resonances afforded by these effective medium structures presents control over thermally induced radiation, and a path for applied thermal engineering. Sample designs of these optical metamaterial emitters as part of thermophotovoltaic cell have demonstrated more than 40% energy conversion efficiency for emitter temperatures below 1500K.

The possible applications for thermophotovoltaics are widely varied. The emitter according to the invention could be used with any process where there is a significant source of heat, such as large internal combustion engines. As an example, coal, oil and gas power plants all rely on the generation of steam at very high temperatures, and end up losing approximately 40% of this energy to waste heat. By making use of thermophotovoltaics this number could be halved.

The above-described embodiments have been provided as examples, for clarity in understanding the invention. A person with skill in the art will recognize that alterations, modifications and variations may be effected to the embodiments described above while remaining within the scope of the invention as defined by claims appended hereto.

1. A thermal emitter, comprising a periodic structure operating as a metamaterial on an optically thick substrate; the periodic structure thermally emitting at high temperatures in a specified narrow wavelength of a predetermined resonance, the metamaterial comprising a composite medium of natural materials.

2. The thermal emitter of claim 1 wherein the emitter is part of a thermophotovoltaic device.

3. The thermal emitter of claim 1 further comprising a plurality of layered films, wherein the distance between each adjacent film is substantially less than the wavelength.

4. The thermal emitter of claim 1 further comprising a plurality of nanowires positioned in the metamaterial, each of the nanowires positioned at a distance from adjacent nanowires and each of the nanowires having a diameter, wherein the distance and the diameter are each significantly less than the wavelength.

5. The thermal emitter of claim 4 wherein significantly less than the wavelength is no greater than 10% of the wavelength over an operational range.

6. The thermal emitter of claim 1 wherein the emitter uses absorption resonances of anisotropic metamaterials for thermal emission.

7. The thermal emitter of claim 1 wherein a composite material in the metamaterial is a high temperature plasmonic material with a frequency at which the relative dielectric response crosses zero and a melting temperature above 800 K.

8. The thermal emitter of claim 1 wherein a composite material in the metamaterial is selected from the group consisting of: an interstitial nitride; a transition metal; and a transparent conductive oxide semiconductor.

9. The thermal emitter of claim 1 wherein a composite material in the metamaterial is selected from the group consisting of: aluminum zinc oxide; tantalum; and titanium nitride.

10. The thermal emitter of claim 1 wherein the thermal emission is reliant upon the thermal excitation of plasmon modes.

11. The thermal emitter of claim 1 wherein the thermal emission occurs at a frequency above a bandgap of a gallium antimonide photovoltaic cell.

12. The thermal emitter of claim 1 wherein the thermal emission is matched to the predetermined resonance, and occurs at an engineered plasma frequency of the metamaterial; the engineered plasma frequency within a frequency region wherein one of the components of a real relative dielectric response of the metamaterial crosses zero.

13. The thermal emitter of claim 1 wherein the thermal emission is matched to the predetermined resonance and occurs in a wavelength region where a relative dielectric response component of the metamaterial has the greatest change of the response component's second derivative with respect to wavelength.

14. The thermal emitter of claim 1 wherein the metamaterial is a high temperature metamaterial.

15. The thermal emitter of claim 1 wherein a composite material of the emitter is titanium oxide.
